(19) United States
(12) Patent Application Publication
(10) Pub. No.: US 2017/0249853 A1
(43) Pub. Date: Aug. 31, 2017

(54) BRAIN STIMULATION SYSTEM AND USES THEREOF

(71) Applicant: WIZE-I LTD, Avihail (IL)

(72) Inventors: Shmuel Weiss, Avihail (IL); Harald Kreutzer, Baiersdorf (DE); Anat Herbet-Grinfeld, Haifa (IL)

(21) Appl. No.: 15/509,155

(22) PCT Filed: Sep. 10, 2015
(86) PCT No.: PCT/IL2015/050928

§ 371 Date: Mar. 6, 2017

Related U.S. Application Data
(60) Provisional application No. 62/050,230, filed on Sep. 15, 2014.

(51) Int. Cl. G09B 5/00

(52) U.S. Cl. CPC G09B 5/00

(57) ABSTRACT

The present disclosure provides devices, systems and methods for enhancing the cognitive activity/ability of a user by providing a watch-only stimulation session with visual features configured to induce stimulation to different brain areas, thereby stimulating a predefined path within the brain of the user.

### TECHNICAL FIELD

The present disclosure generally relates to the field of non-invasive brain stimulation for achieving cognitive enhancements.

### BACKGROUND

Monitoring human brain activity teaches that specific cognitive tasks are associated with enhanced activity of various areas of the brain. For example, the cognitive task of learning a new language is associated with excitation (raised neural activity/blood-flow) of the Prefrontal Cortex, Medial Temporal Lobes and Hippocampus areas of the brain. Studies, relying on this information, provide evidence of enhancement in carrying out specific cognitive tasks by stimulating areas of the brain associated with the tasks.

The stimulation of desired areas of the brain for cognitive enhancement is commonly achieved by several invasive methods, such as motor cortex stimulation (MCS) and deep brain stimulation (DBS), or non-invasive methods, such as transcranial magnetic stimulation (TMS), transcranial current stimulation (TCS) and providing a subject with specific stimulating tasks such as solving specific problems.

Common to current methods is the requirement of the subject to be actively involved in the process by either solving problems or by applying kits to induce electrical/magnetic stimulation to the crania. Requiring from the subject to be active in the stimulation process negatively affects both adherence and compliance to the treatment/stimulation. A certain level of motoric function of the subject may be required in order to interact with current methods. Additionally, current methods focus on the stimulation of targeted areas of the brain that are directly correlated with a specific function and do not provide a solution for an overall enhancement of cognitive abilities.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

According to some embodiments, there are provided herein devices, systems and methods for inducing stimulation in targeted brain regions for achieving cognitive enhancement or modulation.

According to some embodiments, the devices, systems and methods are configured to induce stimulation by providing a user with visual features containing pre-selected visual characteristics configured to induce stimulation to various areas in the brain.

According to some embodiments, the user is provided with a stimulation session and stimulation is advantageously induced without an active motoric engagement of the user in the stimulation session. According to some embodiments, a stimulation session may include multiple stimulation segments; each segment may include one or more visual features having visual characteristics associated with increased brain activity to a known region of the brain. According to some embodiments, different stimulation segments may include visual features having visual characteristics configured to induce stimulation in different areas of the brain, thereby providing a stimulation path or stimulation network.

According to some embodiments, the stimulation path or network comprises a plurality of brain regions/areas, such that stimulating these brain regions in a predetermined order may result in a cognitive enhancement. According to some embodiments, the cognitive enhancement resulting from stimulating the stimulation path or network may be different from the cognitive activities associated with each of the brain regions.

According to some embodiments, there are provided herein devices, systems and methods for enhancing or modulating cognitive ability/functions by providing a sequence of visual and/or audial features to a subject. The features in the sequence configured to induce stimulation to predetermined area(s) in the brain. According to some embodiments, the features are sequenced to induce sequential stimulation to different parts of the brain in a predetermined order.

According to some embodiments, there is provided a brain stimulation device, including a monitor, configured to display visual imagery to a user, a non-transitory memory, configured to store thereon multiple visual features, at least some of the multiple visual features are stimulating visual features having stimuli characteristics for inducing stimulation to predetermined regions of the brain, and a processing circuitry. According to some embodiments, the processing circuitry is configured to define a stimulation path by selecting at least two brain regions for stimulation, create a stimulation session by selecting and sequencing visual features from the stimulating visual features, wherein the selected visual features have stimuli characteristics configured to induce stimulation to the at least two selected brain regions, such that the stimulation session is configured to induce stimulation to the stimulation path, and provide the stimulation session to the monitor.

According to some embodiments, the stimulation session includes a sequence of stimuli-blocks, each stimuli-block is associated with a stimulation of a targeted region of the brain and includes at least one visual feature having stimuli characteristics for inducing stimulation to the targeted region of the brain.

According to some embodiments, the processing circuitry is further configured to assign an exposure time to at least some of the visual features. According to some embodiments, the exposure time is selected from a range of 0.1 seconds to 6 seconds. According to some embodiments, the processing circuitry is further configured to assign a transition rate to at least some of the visual features. According to some embodiments, the transition rate is selected from a range of 12 to 600 transitions per minute.

According to some embodiments, the stimulation session further includes at least one idle-block vacant of stimulating visual features, wherein the stimuli-blocks and the at least one idle-block are serially sequenced.

According to some embodiments, stimuli characteristics are selected from a list of characteristics including: horizontal lines, vertical lines, blank colors, black and white images, grayscale images, perspective lines, human portrait images, emotion indicative images, landscapes, animal images, geometric shapes, irregular shapes, words, vanishing points, fractals, Rorschach images, three-dimensional shapes, two dimensional shapes, optical illusions, textures, patterns, moving images, color images, directions, abstract images, lines, static images, rotating structures, social context, rooms, cityscapes, mathematics, body/body parts, reflections, patterns, gender specific social cues, letters, numbers or any combination thereof.

According to some embodiments, the processing circuitry is configured to obtain a session request from the user; and to define a stimulation path and create a stimulation session subsequent to the obtained request. According to some embodiments, the session request includes: user age, user gender, cognitive enhancement goal, session duration, user hobby, user medical state, user emotional state, training history, or any combination thereof. According to some embodiments, the processing circuitry is further configured to provide a training plan including at least one stimulation session. According to some embodiments, the processing circuitry is further configured to provide a training plan including at least two stimulation sessions. According to some embodiments, the monitor includes a computer screen. According to some embodiments, the monitor includes a mobile-device screen.

According to some embodiments, there is provided a method for inducing brain stimulation to enhance a cognitive ability of a user, the method including defining a stimulation path by selecting at least two brain regions for stimulation, creating a stimulation session by selecting and sequencing visual features from stimulating visual features having stimuli characteristics configured to induce stimulation to the at least two selected brain regions, such that the stimulation session induces stimulation to the stimulation path, and displaying the stimulation on a monitor, wherein the stimulation session does not require an active engagement of the user.

According to some embodiments, at least some of the stimulating visual features are selected in a sequence configured to induce stimulation to at least one region in the brain. According to some embodiments, the selecting and sequencing visual features includes obtaining visual features from a storage device based on stimuli characteristics associated with stimulating the at least two brain regions; assigning an exposure time to at least some of the visual features; and ordering the visual features such that stimulation to different regions of the brain is induced according to the stimulation path. According to some embodiments, the creating the stimulation session includes arranging/sequencing the stimulating visual features to induce sequential stimulation to the at least two brain regions.

According to some embodiments, the creating the stimulation session further includes assigning an exposure time to at least some of the stimulating visual features. According to some embodiments, the creating the stimulation session further includes obtaining from the user a set of parameters, and selecting the stimulating visual features and assigning an exposure time and sequence to the visual features such that the stimulation session meets the set of parameters or a set of rules derived therefrom. According to some embodiments, the set of parameters includes session duration, user age, user gender, cognitive enhancement goal, training duration, user hobby, user medical state, user emotional state and time between sessions. According to some embodiments, the set of rules include session duration, feature-overlapping limit, training duration, and time between sessions.

According to some embodiments, the stimulation session is imbedded within other visual and/or audial media content. According to some embodiments, the other visual and/or audial media content includes entertainment media content. According to some embodiments, the other visual and/or audial media content includes educational media content.

According to some embodiments, there is provided a brain stimulation system, including a server including a server communication controller, a non-transitory memory, configured to store thereon multiple visual features, at least some of the multiple visual features are stimulating visual features having stimuli characteristics for inducing stimulation to predetermined regions of the brain, and a processing circuitry. According to some embodiments, the processing circuitry is configured to define a stimulation path by selecting at least two brain regions for stimulation, create a stimulation session by selecting and sequencing visual features from the stimulating visual features, wherein the selected visual features have stimuli characteristics configured to induce stimulation to the at least two selected brain regions, such that the stimulation session is configured to induce stimulation to the stimulation path, and provide the stimulation session to the server communication controller. According to some embodiments the system further includes a user stimulation-device including a user communication controller, configured to be in communication with the server communication controller and to receive therefrom a stimulation session, and a monitor, configured to display the stimulation session to the user, for inducing stimulation to the stimulation path.

According to some embodiments, the user stimulation device further includes a user input interface configured to obtain user-parameters from the user, and provide the user-parameters to the user communication controller to be delivered to the server communication controller.

According to some embodiments, the server communication controller is configured to obtain the user-parameters from the user communication controller, and deliver the user-parameters to the processing circuitry, wherein the processing circuitry is configured to define a stimulation path and create a stimulation session based on the user-parameters.

According to some embodiments, the user parameters are selected from a list including: user age, user gender, cognitive enhancement goal, session duration, user hobby, user medical state and user emotional state. Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1 schematically illustrates a method for creating and delivering a stimulation session, according to some embodiments;

FIG. 2 schematically illustrates a memory structure for storing stimulating visual features, according to some embodiments;

FIG. 3 schematically illustrates a stimulation session, according to some embodiments;

FIG. 4 schematically illustrates a stimulation path, according to some embodiments;

FIG. 5 schematically illustrates a stimulation session creation, according to some embodiments;

FIG. 6a schematically illustrates sequencing/ordering of visual features for stimulating the Primary visual cortex, according to some embodiments;

FIG. 6b schematically illustrates sequencing/ordering of visual features for stimulating the sensorimotor area, according to some embodiments;

FIG. 7 schematically illustrates a block diagram of a system for brain stimulation, according to some embodiments; and

FIG. 8 schematically illustrates a block diagram of a server and a user system for brain stimulation, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, there are provided herein devices, systems and methods for inducing stimulation in targeted brain regions for achieving cognitive enhancement. According to some embodiments, the devices, systems and methods are configured to induce stimulation by providing a user with visual features containing visual characteristics configured to induce stimulation to various areas in the brain.

According to some embodiments, a user is provided with a stimulation presentation/session and is instructed to focus his vision on the presentation without being actively involved or being required to perform certain actions, such as solving problems or the like. According to some embodiments, a stimulation session may include a plurality of visual features; each visual feature is exposed for a defined exposure time, and the features are ordered for inducing stimulation to certain brain regions/areas of the user viewing the presentation.

According to some embodiments, the visual features in the presentation may include visual characteristics that are known to induce stimulation to defined regions in the brain of a viewer, and different visual characteristics may induce stimulation of different regions of the brain. Therefore, according to some embodiments, providing a viewer with visual features containing stimulating visual characteristics in a defined order, may induce stimulation to different regions of the brain based on the order of the visual characteristics (that are imbedded/comprised in the visual features) presented.

According to some embodiments, the user is provided with a stimulation session and stimulation is induced without an active engagement of the user in the stimulation session, such an active engagement may be motoric or non-motoric. According to some embodiments, a stimulation session may include multiple stimulation segments; each segment may include one or more visual features having visual characteristics associated with increased brain activity to a known region of the brain. According to some embodiments, different stimulation segments may include visual features having visual characteristics configured to induce stimulation in different areas of the brain, thereby providing a stimulation path.

According to some embodiments, the session/presentation is a “watch-only” presentation, wherein a user is required to only focus his/her eyesight on the presentation. According to some embodiments, the session/presentation is an attentive “watch-only” presentation, wherein a user is required to only focus his/her eyesight on the presentation and focus his mental attention on the presented sequence. Advantageously, such “watch-only” or attentive “watch-only” presentations may induce stimulation to various regions of the brain and result in cognitive enhancements without an active engagement of the user in the stimulation process/session.

As used herein, the term “active engagement” and the term “motor active engagement” may refer to the requirement of actions from the user as part of the stimulation session. Such an engagement may include motor engagement such as moving objects, or moving a limb in a certain manner Other forms of active engagement may include requesting the user to solve a puzzle or provide an answer to a question.

According to some embodiments, the stimulation path comprises a plurality of brain regions/areas, such that stimulating these brain regions in a predetermined order may result in a cognitive enhancement or modulation. According to some embodiments, the cognitive enhancement or modulation resulting from stimulating the stimulation path may be different from the cognitive activities associated with each of the brain regions.

According to some embodiments, there are provided herein devices, systems and methods for enhancing cognitive ability/functions by providing a sequence of visual and/or audial features to a subject. According to some embodiments, the features in the sequence are configured to induce stimulation to predetermined area(s) in the brain. According to some embodiments, the features are sequenced to induce sequential or simultaneous stimulation to different parts of the brain in a predetermined order.

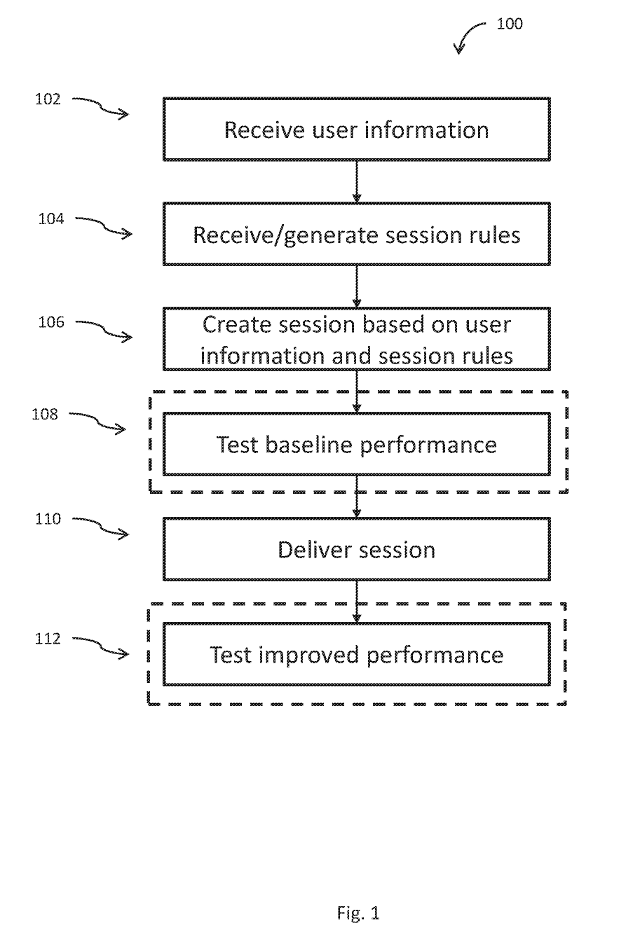

Reference is now made to FIG. 1, which schematically illustrates a method for creating and delivering a stimulation session 100, according to some embodiments. According to some embodiments, the stimulation session is preceded by receiving information related to the user (step 102); the information may include the age of the user, a cognitive enhancement goal, the gender, hobby, physical and mental states, and the like. Then according to some embodiments, session rules may be provided by the user or generated according to the user information (step 104); the session rules may include session duration, exposure time and/or overlap time of visual features, and the like. Then the session is created based on the user information and the session rules (step 106). The creation of the session may include determining a stimulation path, for example, based on the cognitive enhancement goal, and selecting visual features, ordering and assigning exposure information to them in order to induce stimulation to the various regions of the brain according to the determined stimulation path. Optionally, a user may conduct a baseline performance test (step 108) to assess the cognitive performance of the user prior to viewing the session/presentation, and then the session may be delivered to the user (step 110). According to some embodiments, a user may optionally conduct a second cognitive performance test (step 112) to assess the cognitive performance thereof after the presentation.

According to some embodiments, the devices/systems for generating and/or delivering the session(s)/presentation(s) may include processing circuitry configured to perform various computational steps for generating the presentation. According to some embodiments, the devices/systems may further include a non-transitory memory unit/component having stored thereon a plurality of visual features having stimulating visual characteristics; and the processing circuitry is configured to select visual features for the session from the memory unit based on the relevance of their visual characteristics and the desired regions of the brain to be stimulated.

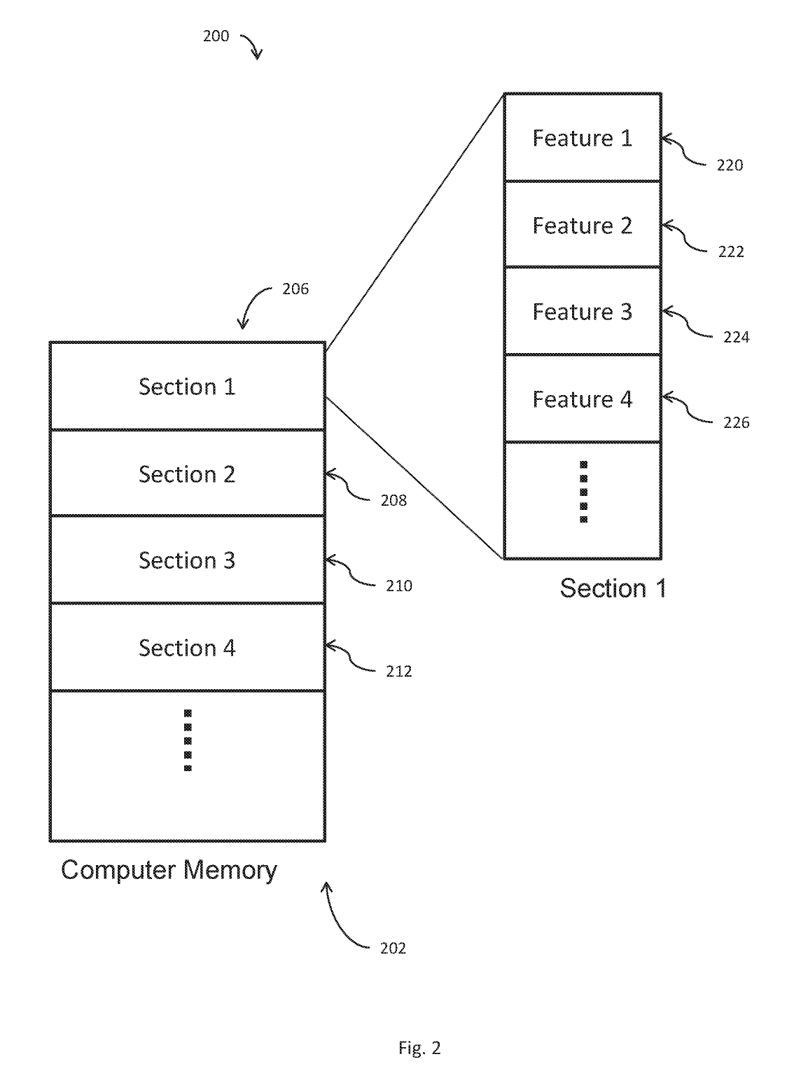

Reference is now made to FIG. 2, which schematically illustrates a memory structure 200 for storing stimulation visual features, according to some embodiments. According to some embodiments, memory structure 200 includes a non-transitory memory unit, such as computer memory 202, which includes multiple sections or libraries, such as section 1 206, section 2 208, section 3 210, and section 4 212, wherein each section is configured to contain or contains visual features. For example, section 1 206 includes multiple features such as feature 1 220, feature 2 222, feature 3 224 and feature 4 226.

According to some embodiments, the visual features may contain/have visual characteristics for inducing stimulation to various regions of the brain. According to some embodiments, visual features that have visual characteristics for inducing stimulation to a certain region of the brain, may be stored/clustered into one section, thereby organizing the memory such that each section contains visual features having features for inducing stimulation to a defined brain region(s). In other words, each section may be associated with the stimulation of a defined brain region(s), such that in the creation of the stimulation session/presentation, the visual features are selected based on the sections in which they are stored.

According to some embodiments, the visual features may contain/have visual characteristics for inducing stimulation to various regions of the brain. According to some embodiments, the visual features may be stored in the memory with meta-data associated therewith. According to some embodiments, the meta-data may include information regarding the visual characteristics of the visual feature, the associated brain region, or the like. According to some embodiments, when a stimulation session/presentation is created, the visual features are selected based on their meta-data.

The result of the session creation process may be a presentation with multiple visual features, each visual feature being exposed for a defined period of time. According to some embodiments, the presentation may include blocks; each block is associated with inducing stimulation to a known/defined brain region(s), and the blocks are ordered for inducing stimulation to a different brain region in a corresponding sequence, thereby creating a stimulation path or a stimulation network.

As used herein, the term stimulation network may refer to a plurality of brain regions in a stimulation session, such that at least some of the brain regions are serially stimulated, and, according to some embodiments, some brain regions may be simultaneously stimulated and/or have a stimulation overlap.

As used herein, the terms “stimulation path” and “stimulation network” may be interchangeable.

As used herein, the term “multiple” may refer to two or more items.

As used herein, the term “at least some” may refer to two or more items.

As used herein, the term “set of parameters” may refer to one or more parameters.

As used herein, the terms “sequencing” and “ordering” may be interchangeable, and refer to arranging items in an order or sequence.

According to some embodiments, providing a viewer with a visual feature, having stimulating visual characteristics, induces an increased neuronal activity thus an increase of blood supply to the brain region associated with the stimulating visual characteristics. According to some embodiments, the increase of neuronal activity to a region of the brain may be referred to as an “excitation” of that brain region.

According to some embodiments, a plurality of visual features may be sequenced/ordered in a certain way for providing a visual characteristic(s). For example, visual features may be ordered for providing a gradient in color, sequenced numbers/values, non-continuous/disrupted sequence of numbers/values, and the like.

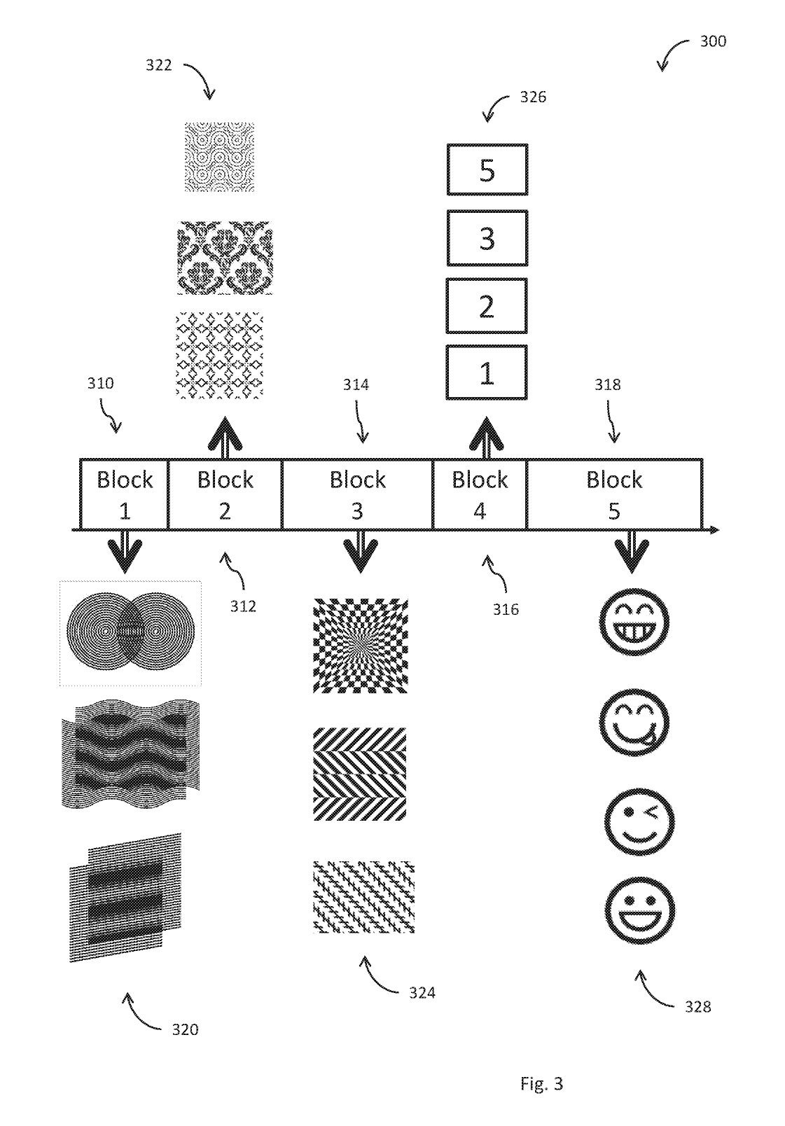

Reference is now made to FIG. 3, which schematically illustrates an exemplary stimulation presentation 300, according to some embodiments. According to some embodiments, presentation 300 includes a plurality of presentation blocks, such as stimulation block 1 310, stimulation block 2 312, block 3 314, block 4 316, and block 5 318. Blocks 1 through 5 (310, 312, 314, 316 and 318) are configured to each induce stimulation to a different region of the brain, and are ordered sequentially such that a sequential stimulation of the respective brain regions is induced, thereby resulting in a stimulated path in the brain of the user/viewer.

As exemplary illustrated, block 1 310 includes a plurality of visual features having the stimulating visual feature of interleaving patterns 320. Block 2 312 includes a plurality of visual features having the stimulating visual characteristics of repetitive patterns 322. Block 3 314 includes a plurality of visual features having the stimulating visual characteristics of optical illusions 324. Block 5 318 includes a plurality of visual features having the stimulating visual characteristics of positive emoji icons 328, while block 4 316 includes visual features that are ordered for providing a combined stimulating visual characteristic such as disrupted sequence of numbers 326.

According to some embodiments, blocks 1 through 5 (310, 312, 314, 316 and 318) may each be assigned time intervals/periods that are different in length. Alternatively, according to some embodiments, blocks 1 through 5 (310, 312, 314, 316 and 318) may each be assigned time intervals/periods that are equal in length.

According to some embodiments, a user may insert parameters that include a cognitive function for enhancement/training, and then a stimulation path is determined based on the cognitive function; the stimulation path comprises a series of brain regions. According to some embodiments, the stimulation path is determined such that inducing stimulation to the series of the brain region of the path induces an increased neural activity thus increase blood-flow in these brain regions at a sequence determined by the stimulation path.

In some embodiments, the cognitive functions may include: short term memory, long term memory, association, concept formation, pattern recognition, languages, attention, perception, action, problem solving, mental imagery, navigation, reasoning, reading speed, level of consciousness, and the like.

In some embodiments, various brain regions may be included in stimulation paths associated with at least some of the cognitive functions. In some embodiments, the brain regions may include: the frontal lobe, the parietal lobe, the occipital lobe, the cerebellum, the brainstem and/or parts thereof such as: corona radiata, internal capsule, external capsule, extreme capsule, arcuate fasciculus and uncinate fasciculus. The brain regions may also include the medial temporal lobe, such as, dentate gyrus, cornu ammonis, amygdala: central nucleus, medial nucleus, cortical and basomedial nuclei, and lateral and basolateral nuclei. The brain regions may also include claustrum and the basal ganglia, such as, striatum, including the dorsal striatum, dorsal striatum, putamen, caudate nucleus, ventral striatum, nucleus accumbens and olfactory tubercle. The brain regions may also include globus pallidus (forms nucleus lentiformis with putamen), subthalamic nucleus and basal forebrain, such as, anterior perforated substance, substantia innominata, nucleus basalis, diagonal band of broca, and medial septal nuclei. The brain regions may also include rhinencephalon: Olfactory bulb, piriform cortex, anterior olfactory nucleus, olfactory tract, anterior commissure, uncus, and cerebral cortex. The brain regions may also include frontal lobe: primary motor cortex (precentral gyrus, m1), supplementary motor cortex, premotor cortex, prefrontal cortex, superior frontal gyrus, middle frontal gyrus, inferior frontal gyrus brodmann areas: 4, 6, 8, 9, 10, 11, 12, 24, 25, 32, 33, 44, 45, 46, 47; parietal lobe: primary somatosensory cortex (S1), secondary somatosensory cortex (S2), posterior parietal cortex, postcentral gyrus (primary somesthetic area), precuneus, brodmann areas 1, 2, 3 (primary somesthetic area); 5, 7, 23, 26, 29, 31, 39, 40; occipital lobe: primary visual cortex (V1), v2, v3, v4, v5/mt, lateral occipital gyrus, cuneus, brodmann areas 17 (v1, primary visual cortex) 18, 19; temporal lobe: cortex: primary auditory cortex (A1), secondary auditory cortex (A2), inferior temporal cortex, posterior inferior temporal cortex; gyri: superior temporal gyrus, middle temporal gyrus, inferior temporal gyrus, fusiform gyrus, parahippocampal gyrus; Brodmann areas: 9, 20, 21, 22, 27, 34, 35, 36, 37, 38, 41, 42; medial superior temporal area (MST); insular cortex; and cingulate cortex: anterior cingulate, posterior cingulate, retrosplenial cortex, indusium griseum, subgenual area 25, Brodmann, areas 23, 24; 26, 29, 30 (retrosplenial areas); 31, and 32.

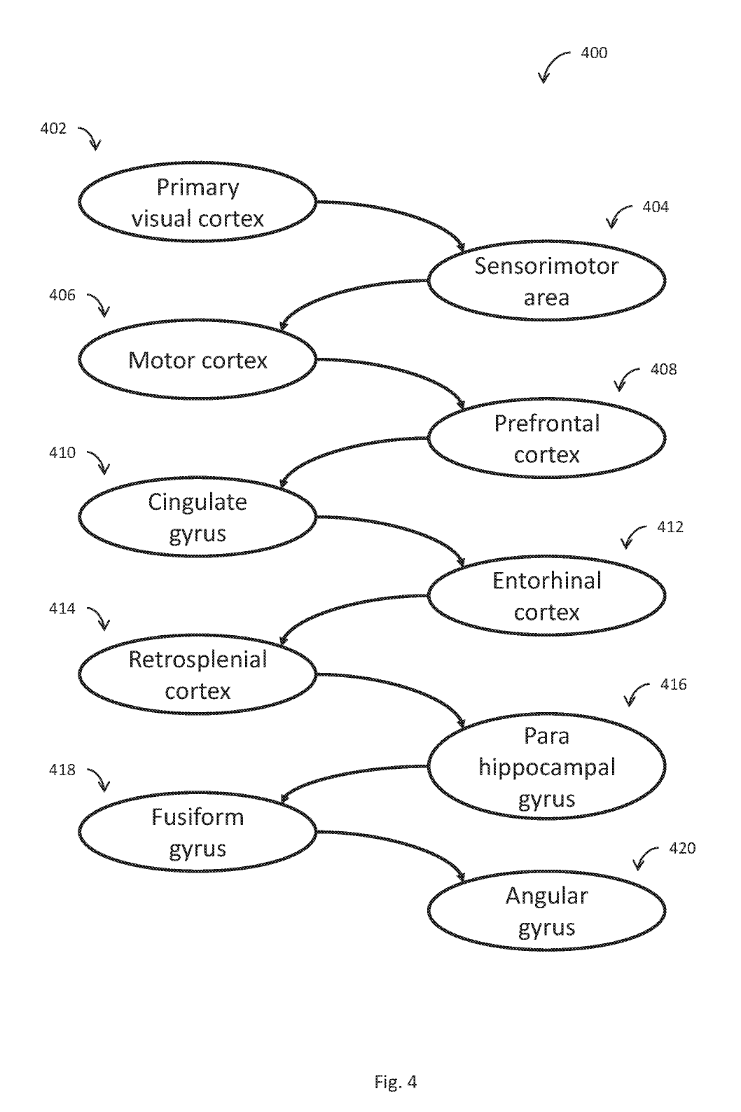

Reference is now made to FIG. 4, which schematically illustrates a stimulation path 400 determined for enhancing the cognitive function of working memory, according to some embodiments. The path begins with the Primary visual cortex 402, then continues serially to the Sensorimotor area 404, the Motor Cortex 406, the Prefrontal cortex 408, the Cingulate Gyrus 410, the Entorhinal cortex 412, the Retrosplenial cortex 414, the Parahippocampal gyrus 416, the Fusiform gyrus 418 and the path end with the Angular gyrus 420.

According to some embodiments, the stimulation path is stimulated in a single iteration. According to some embodiments, the stimulation path is recursively/iteratively stimulated. According to some embodiments, the various iterations of the stimulation path are similar in context and arrangement. According to some embodiments, various iterations may include different brain regions, skipping of certain brain regions, varying order between brain regions, different stimulating visual features within the regions or any combination thereof.

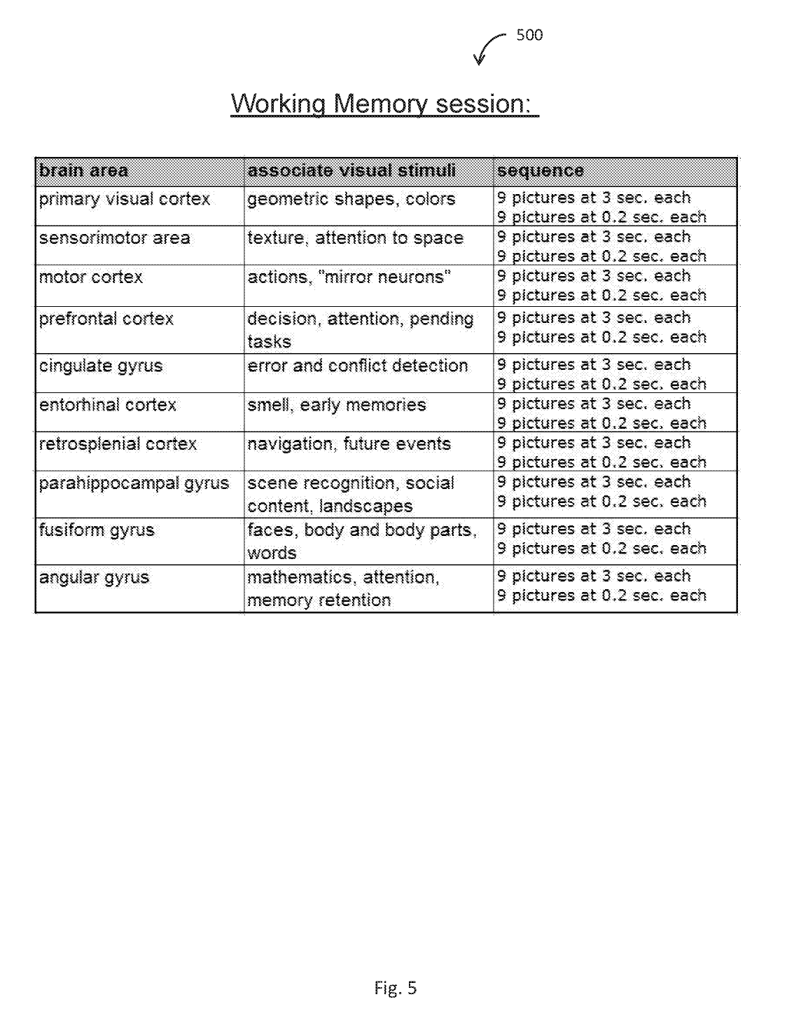

Reference is now made to FIG. 5, which schematically illustrates a stimulation session overview 500, according to some embodiments. According to some embodiments, stimulation session overview 500 relates to a session based on a stimulation path targeting the cognitive function of working memory for exemplary purposes. The path was determined to serially stimulate the following brain regions: the primary visual cortex, the sensorimotor cortex, the motor cortex, the prefrontal cortex, the cingulate gyrus, the entorhinal cortex, the retrosplenial cortex, the parahippocampal gyrus, the Fusiform gyrus, and the angular gyrus.

The stimulating visual characteristics associated with each of the regions are as follows:

The primary visual cortex, is stimulated by visual characteristics that include geometric shapes and colors.

The sensorimotor cortex, is stimulated by visual characteristics that include texture and attention to space.

The motor cortex, is stimulated by visual characteristics that include actions and minor neurons.

The prefrontal cortex, is stimulated by visual characteristics that include decision, attention and task in a pending state.

The cingulate gyrus, is stimulated by visual characteristics that include error conflict detection.

The entorhinal cortex, is stimulated by visual characteristics that include smell and early memories.

The retrosplenial cortex, is stimulated by visual characteristics that include navigation and future events.

The parahippocampal gyrus, is stimulated by visual characteristics that include scene recognition, social content and landscapes.

The Fusiform gyrus, is stimulated by visual characteristics that include faces, body or body parts and words.

The angular gyrus, is stimulated by visual characteristics that include mathematics, attention, and memory retention.

As exemplified, one of the session rules may be a session duration of less than 5 minutes, the sequence of the visual features within the blocks associated with each of the brain regions, and the repetitiveness and exposure time of the visual features may be determined according to the session duration rule. In stimulation session overview 500, 9 visual features were selected for each of the blocks, and each of the visual features was exposed two times, a first exposure lasting approximately 3 seconds, and a second exposure lasting 0.2 seconds. According to some embodiments, the long exposures within a block may precede the short exposures within that block.

The aggregate of the exposure times of all the features within all the blocks sums up to 288 seconds according to this example, thereby meeting the session duration rule of 5 minutes (300 seconds).

According to some embodiments, visual features may also refer to audial features of the combination of audial, visual and/or other sensory features. According to some embodiments, visual features may include images/figures.

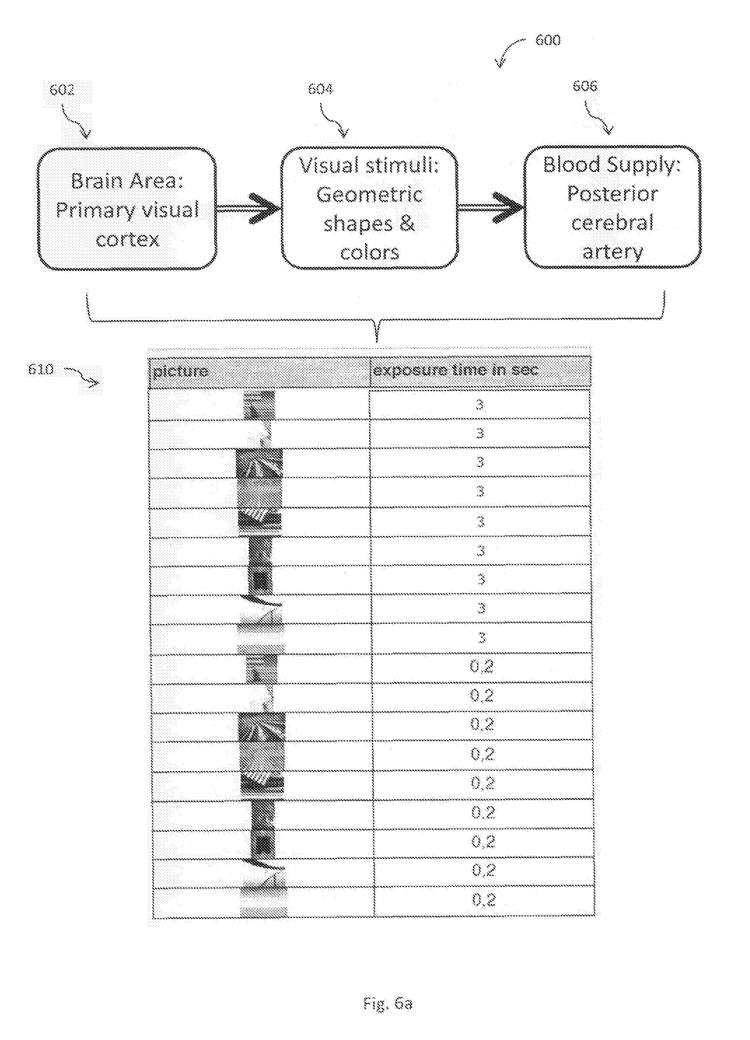

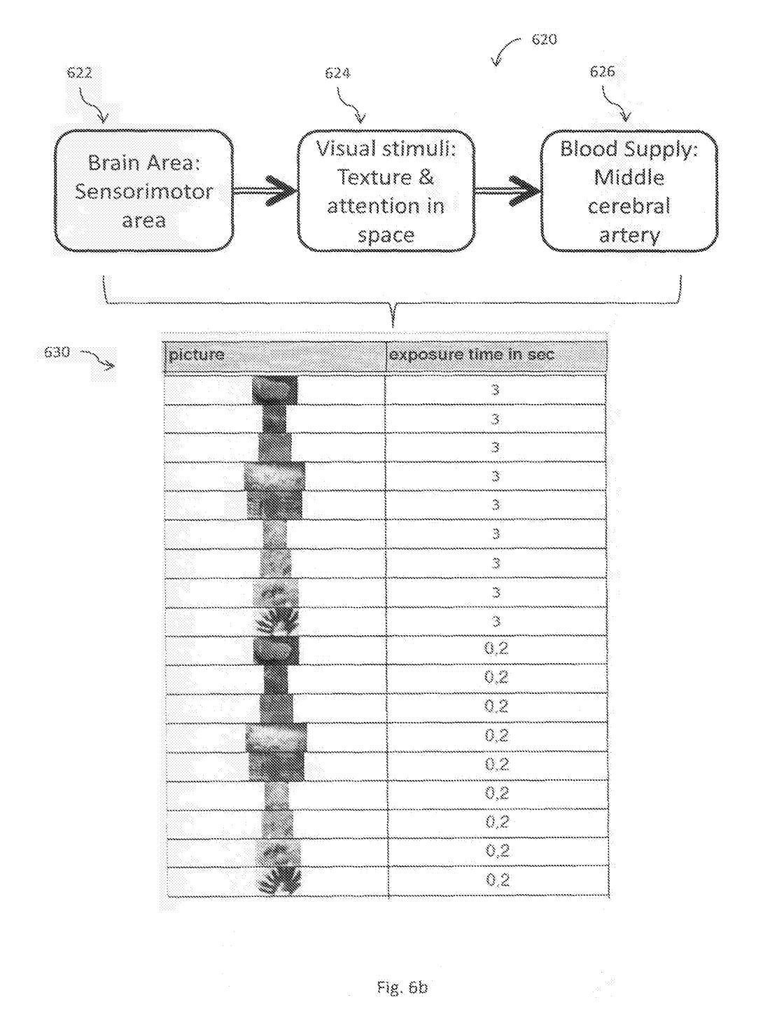

Reference is now made to FIG. 6a, which schematically illustrates sequencing/ordering of visual features 600 for stimulating the Primary visual cortex, according to some embodiments. According to some embodiments, when a certain brain region is selected, such as a primary visual cortex 602, the visual stimuli characteristics associated with stimulating that regions are selected, such as geometric shapes and colors 604, which are designed to induce a neuronal activity thus an increased/aroused blood flow to an area in the brain 606, supplied by the posterior cerebral artery or its branch(es), that conduct/s the blood to the primary visual cortex. A specific sequence 610 of visual features is then selected. As exemplified, visual sequence 610 includes a sequence of 9 pictures/figures, each being assigned an exposure time of 3 seconds, and then another sequence of the same 9 pictures/figures is selected, this time each being assigned an exposure time of 0.2 seconds.

Reference is now made to FIG. 6b, which schematically illustrates sequencing/ordering of visual features 620 for stimulating the sensorimotor area, according to some embodiments. According to some embodiments, when a certain brain region is selected, such as a sensorimotor area 622, the visual stimuli characteristics associated with stimulating that regions are selected, such as textures and attention in space 624, which are designed to induce a neuronal activity thus an increased/aroused blood flow to an area in the brain, supplied by the middle cerebral artery or its branches 626. A specific sequence 630 of visual features is then selected. As exemplified, visual sequence 630 includes a sequence of 9 pictures/figures, each being assigned an exposure time of 3 seconds, and then another sequence of the same 9 pictures/figures is selected, this time each being assigned an exposure time of 0.2 seconds.

According to some embodiments, the order of the brain regions in the stimulation path is based on the anatomic/spatial proximity of the different brain regions in the path. According to some embodiments, areas that are anatomically/spatially approximate may be stimulates in a corresponding temporal proximity.

According to some embodiments, the order of the brain regions in the stimulation path is based on the functional network between the different brain regions in the path. According to some embodiments, brain regions that are functionally connected may be in temporal proximity in the stimulation session.

According to some embodiments, the order of brain regions in the stimulation path is based on the brain hubs which contain the different brain regions. According to some embodiments, brain regions that are within the same brain hub may be in temporal proximity in the stimulation session.

According to some embodiments, the order of the brain regions in the stimulation path is based on the neural pathways in the brain. According to some embodiments, brain regions in the stimulation path are ordered to match their order in the neural pathways.

According to some embodiments, the user may be provided with a training plan, which may include one or more sessions. According to some embodiments, the training plan may include a plurality of training/stimulation sessions. According to some embodiments, the training plan may include advice on recommended activities between sessions. According to some embodiments, the training plan may include a “time-between-sessions” parameter.

According to some embodiments, the stimulation session may be imbedded with other media, such as movies, web-pages, lectures, video broadcasts and the like. According to some embodiments, the session embedded within media content may be designed to enhance a cognitive function related to the other media content in which it is imbedded. According to some embodiments, the visual features of the session may comprise a plurality of video/image frames, inserted between or replacing some of the frames of the other media content.

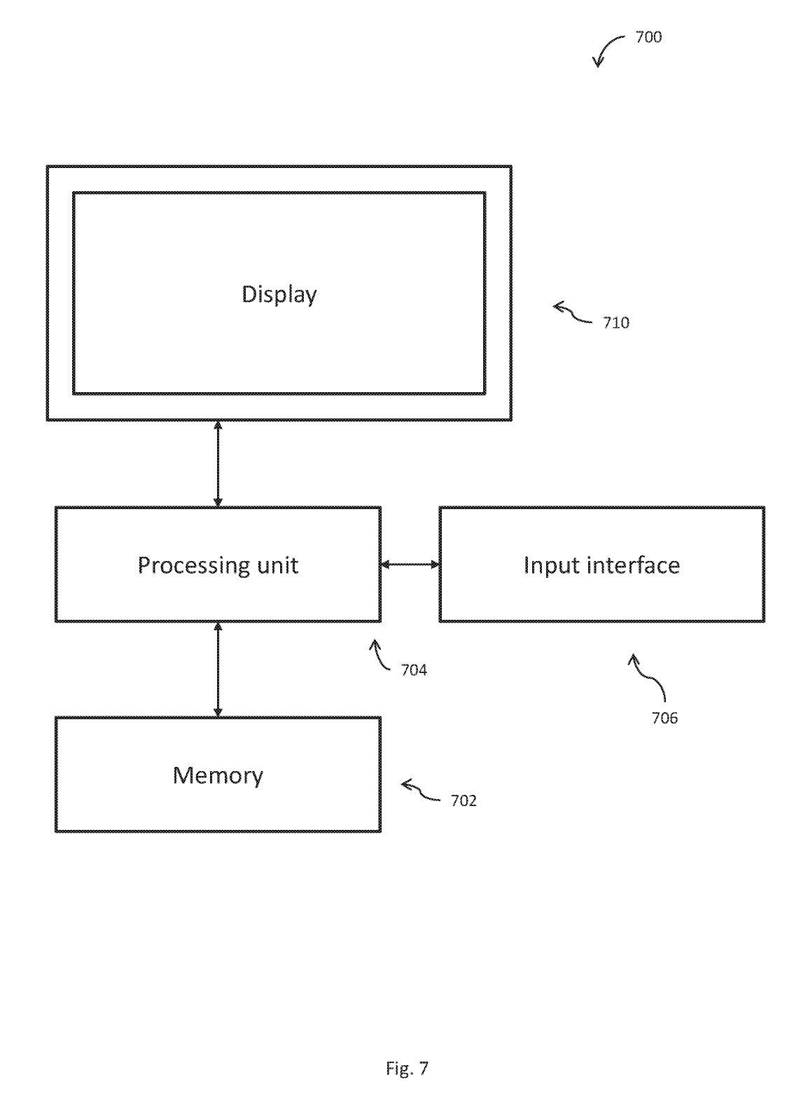

Reference is now made to FIG. 7, which schematically illustrates a block diagram of a system 700 for brain stimulation, according to some embodiments. According to some embodiments, system 700 includes processing circuitry, such as a processing unit 704, connected to a memory 702 that may include a plurality of visual features, associations between cognitive functions and stimulation paths, associations between brain regions and visual characteristics, associations between visual characteristics and visual features, statistics, user history or plan and/or the like. Processing unit 704 is configured to select/obtain various visual features from memory 702 for generating a stimulation presentation/session and delivering the session through a monitor, such as display 710. According to some embodiments, processing unit 704 may further be connected to an input interface 706 for obtaining information regarding the session or control thereof from a user. The input may include session or user parameters, initiation signal, termination signal or the like.

According to some embodiments, memory 702 may have stored thereon pre-obtained/pre-generated sessions/presentations; and processing circuitry 704 is configured to select the session/presentation and provide it to display 710.

According to some embodiments, memory 702 is a non-transitory memory such as a hard-drive, a solid-state drive, a flash-disc, a magnetic medium, or the like. According to some embodiments, memory 702 is a distributed and/or non-local memory such as a cloud memory, or the like.

According to some embodiments, the monitor may include a projector, a television screen, a mobile phone screen, a phablet screen, a tablet screen, a desktop screen, a laptop screen, a wearable-device screen, a car windshield screen or projection, a car display, a display minor, a screen embedded with eyewear devices, a screen embedded within clothing, virtual reality devices, augmented reality devices, or the like.

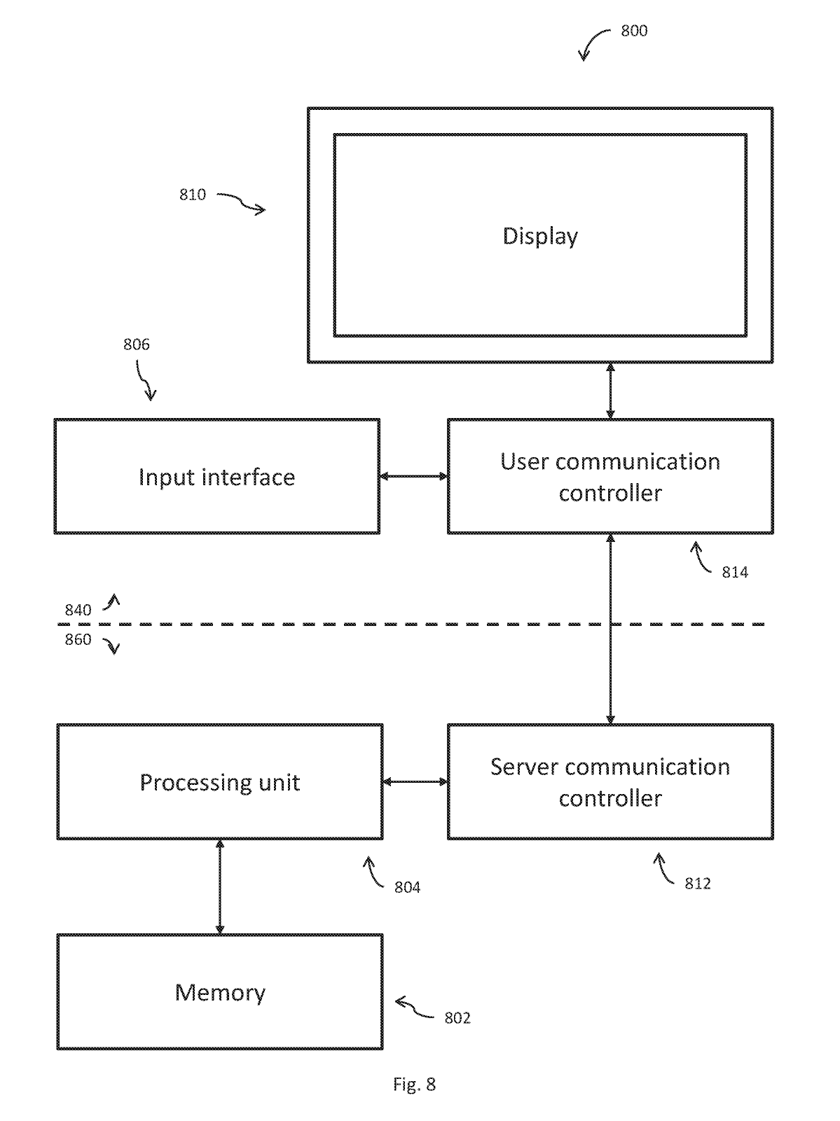

Reference is now made to FIG. 8, which schematically illustrates a block diagram of a server and a user system 800 for brain stimulation, according to some embodiments. According to some embodiments, system 800 includes a user side 840 and a server side 860 that are in communication or may be in communication. According to some embodiments, server side 860 includes a processing unit 804, configured to create a stimulation session or a plan of stimulation session by sequencing/ordering various visual features stored on a memory 802. According to some embodiments, processing circuitry is connected to a server communication controller 812 for communicating with user side 840 via a user communication controller 814 at user side 840.

According to some embodiments, the communication between user side 840 and server side 860 may be for the purposes of providing the session, for obtaining control information, for obtaining a session parameter(s), and others.

According to some embodiments, user side 840 further includes a display, and includes user communication controller 814, which is configured to obtain a stimulation presentation/session from server side 860 and provide it to display 810. User side 840 may further include an input interface 806 for obtaining control information, user parameters, session parameters, and the like, from a user. The obtained input may be used in the creation of the session and/or the control over the display/delivery thereof.

According to some embodiments, user side 840 may include a desktop computer, a laptop, a mobile phone, a tablet, a television, a wearable device, and others. According to some embodiments, server side 860 may be an internet server, a local server, a virtual computing machine, or the like. According to some embodiments, the communication between user side 840 and server side 860 may be wired, wireless, encrypted, secured, point-to-point, virtual, the like, or any combination thereof.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### EXAMPLES

### Example 1

In an experiment, 40 subjects were randomly selected from various ages, hobbies, backgrounds, professions, education levels and interests to be representative of a population.

The subjects were tested at different times of day and in different settings.

20 subjects were tested as follows:
perform a short memory test
view a presentation according to the principles of the present disclosure for 4 minutes, and targeting the short term memory cognitive function.
wait for 5 minutes,
perform a second short memory test,
wait for 5 minutes,
perform a third short memory test.

20 other subjects were tested as follows:
perform a short memory test
wait 5 minutes
perform a second short memory test
view a presentation according to the principles of the present disclosure for 4 minutes, and targeting the short term memory cognitive function.
wait 5 minutes
perform a third short memory test.

Results of the first memory test showed an improvement of 68% of performance between both groups (based on the total number of correct answers items that the subjects managed to answer) when only the first group was exposed to the presentation according to the principles of the present disclosure.

Results of the second memory test showed an improvement of 31% of performance between both groups (based on the total number of correct answers items that the subjects managed to answer) when the second group was also exposed to the presentation according to the principles of the present disclosure.

The second memory test shows that after both groups were exposed to the presentation, the gap in performance between both groups was shortened.

### Example 2

An experiment is conducted on 180 subjects to test the cognitive function of attention improvement, and the correlation with a stimulation session according to the disclosure.

The 180 subjects are divided into three groups:
Group A: the experimental group exposed to a stimulation session created and sequenced according to the teaching disclosed herein.
Group B: the first control group exposed to a random session of visual features.
Group C: the second control group not exposed to any session, but merely wait the same time window as Groups A and B between the baseline and second attention tests.

Subjects are healthy men and women in the range of 25 to 45 years of age.

The experiment is conducted as follows:

Group A
a baseline attention test is performed.
Subjects are not exposed to further test within the following 36 hours
After a period of 36 hours, subjects are allowed to watch 12 presentations according to the disclosure, each presentation lasts 5 minutes, and the presentations are presented in a rate of one presentation every two days. The entire session is spanned over a period of 24 days.
After completion of the last presentation, no further test are performed for 24 hours.
After a period of 24 hours, a second attention test is performed.

Group B
a baseline attention test is performed.
Subjects are not exposed to further test within the following 36 hours.
After a period of 36 hours, subjects are allowed to watch 12 random presentations, each presentation lasted 5 minutes, and the presentations are presented in a rate of one presentation every two days. The entire session is spanned over a period of 24 days.
After completion of the last presentation, no further test are performed for 24 hours.
After a period of 24 hours, a second attention test is performed.

Group C
conduct a baseline attention test
wait to match the attention tests times of groups A and B.
conduct a second attention test

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1-29. (canceled)

30. A brain stimulation device for enhancing a cognitive function of a user, the brain stimulation device comprising:
a monitor configured to display visual imagery to the user;
a non-transitory memory configured to store thereon multiple visual features, at least some of the multiple visual features are stimulating visual features having stimuli characteristics for inducing stimulation to predetermined regions of the brain; and
a processing circuitry configured to:
define a stimulation path by selecting at least two brain regions for stimulation, wherein inducing stimulation to the stimulation path is associated with affecting an enhancement to the cognitive function of the user;
create a stimulation session by selecting and sequencing visual features from the stimulating visual features, wherein the selected visual features have stimuli characteristics configured to induce stimulation to the at least two selected brain regions, such that the stimulation session is configured to induce stimulation to the stimulation path; and
provide the stimulation session to the monitor.

31. The brain stimulation device of claim 30, wherein the stimulation session includes a sequence of stimuli-blocks, each of the sequence of stimuli-blocks is associated with a stimulation of a targeted region of the brain and includes at least one visual feature having stimuli characteristics for inducing stimulation to the targeted region of the brain.

32. The brain stimulation device of claim 31, wherein the processing circuitry is further configured to assign an exposure time to at least some of the visual features, wherein the exposure time is within a range of 0.1 seconds to 6 seconds.

33. The brain stimulation device of claim 31, wherein the processing circuitry is further configured to assign a transition rate to at least some of the visual features, wherein the transition rate is within a range of 12 to 600 transitions per minute.

34. The brain stimulation device of claim 31, wherein the stimulation session includes at least one idle-block vacant of stimulating visual features, wherein the stimuli-blocks and the at least one idle-block are serially sequenced.

35. The brain stimulation device of claim 30, wherein the stimuli characteristics are selected from the group consisting of horizontal lines, vertical lines, blank colors, black and white images, grayscale images, perspective lines, human portrait images, emotion indicative images, landscapes, animal images, geometric shapes, irregular shapes, words, vanishing points, fractals, Rorschach images, three-dimensional shapes, two dimensional shapes, optical illusions, textures, patterns, moving images, color images, directions, abstract images, lines, static images, rotating structures, social context, rooms, cityscapes, mathematics, body/body parts, reflections, patterns, gender specific social cues, letters, numbers, and any combination thereof.

36. The brain stimulation device of claim 30, wherein the processing circuitry is configured to obtain a session request from the user; and to define a stimulation path and create a stimulation session subsequent to the session request obtained from the user.

37. The brain stimulation device of claim 36, wherein the session request includes user age, user gender, cognitive enhancement goal, session duration, user hobby, user medical state, user emotional state, training history, or any combination thereof.

38. The brain stimulation device of claim 37, wherein the processing circuitry is further configured to provide a training plan including at least one stimulation session.

39. The brain stimulation device of claim 30, wherein the monitor includes a computer screen or a mobile device screen.

40. A method for inducing brain stimulation to enhance a cognitive function of a user, the method comprising:
defining a stimulation path by selecting at least two brain regions for stimulation, wherein inducing stimulation to the stimulation path is associated with affecting an enhancement to the cognitive function of the user;
creating a stimulation session by selecting and sequencing visual features from stimulating visual features having stimuli characteristics configured to induce stimulation to the at least two selected brain regions, such that the stimulation session induces stimulation to the stimulation path; and
displaying the stimulation session on a monitor;
wherein the stimulation session does not require an active engagement of the user.

41. The method of claim 40, wherein at least some of the stimulating visual features are selected in a sequence configured to induce stimulation to at least one of the brain regions.

42. The method of claim 41, wherein the selecting and sequencing visual features includes:
obtaining visual features from a storage device based on stimuli characteristics associated with stimulating the at least two brain regions;
assigning an exposure time to at least some of the visual features; and
ordering the visual features such that stimulation to different regions of the brain from the at least two brain regions is induced according to the stimulation path.

43. The method of claim 40, wherein the creating the stimulation session includes arranging the stimulating visual features to induce sequential stimulation to the at least two brain regions.

44. The method of claim 40, wherein the creating the stimulation session further includes assigning an exposure time to at least some of the stimulating visual features.

45. The method of claim 40, wherein the creating the stimulation session includes:
obtaining from the user a set of parameters, and selecting the stimulating visual features; and
assigning an exposure time and sequence to the visual features such that the stimulation session meets the set of parameters or a set of rules derived therefrom.

46. The method of claim 45, wherein the set of parameters includes at least one of session duration, user age, user gender, cognitive enhancement goal, training duration, user hobby, user medical state, user emotional state, or time between sessions.

47. The method of claim 45, wherein the set of rules include at least one of session duration, feature-overlapping limit, training duration, or time between sessions.

48. The method of claim 40, wherein the stimulation session is embedded within other visual and/or audial media content including entertainment media content and/or educational media content.

49. A brain stimulation system for enhancing a cognitive function of a user, the system comprising:
a server including:
a server communication controller;
a non-transitory memory configured to store thereon multiple visual features, at least some of the multiple visual features are stimulating visual features having stimuli characteristics for inducing stimulation to predetermined regions of the brain; and
a processing circuitry configured to:
define a stimulation path by selecting at least two brain regions for stimulation, wherein inducing stimulation to the stimulation path is associated with affecting an enhancement to the cognitive function of the user;
create a stimulation session by selecting and sequencing visual features from the stimulating visual features, wherein the selected visual features have stimuli characteristics configured to induce stimulation to the at least two selected brain regions, such that the stimulation session is configured to induce stimulation to the stimulation path; and
provide the stimulation session to the server communication controller;
and
a user stimulation-device including:
a user communication controller configured to be in communication with the server communication controller and to receive therefrom a stimulation session; and
a monitor configured to display the stimulation session to the user, for inducing stimulation to the stimulation path.

50. The brain stimulation system of claim 49, wherein the user stimulation device further includes a user input interface configured to:
obtain user-parameters from the user; and
provide the user-parameters to the user communication controller to be delivered to the server communication controller.

51. The brain stimulation system of claim 50, wherein:
the server communication controller is configured to obtain the user-parameters from the user communication controller, and deliver the user-parameters to the processing circuitry;
the processing circuitry is configured to define a stimulation path and create a stimulation session based on the user-parameters.

52. The brain stimulation system of claim 51, wherein the user parameters include at least one of user age, user gender, cognitive enhancement goal, session duration, user hobby, user medical state, or user emotional state.
